(19) United States
(12) Patent Application Publication
(10) Pub. No.: US 2004/0165148 A1
(43) Pub. Date: Aug. 26, 2004

(54) Movement suggestion and motivation methods and related means

(76) Inventor: Carl John Macinnes, Auckland (NZ)

Correspondence Address: JACOBSON HOLMAN PLLC, 400 SEVENTH STREET N.W., SUITE 600, WASHINGTON, DC, 20004, US

(21) Appl. No.: 10/474,204

(22) PCT Filed: Apr. 19, 2002
(86) PCT No.: PCT/NZ02/00068

(30) Foreign Application Priority Data
Apr. 19, 2001 (NZ) 511191

(51) Int. Cl. G03B 21/32

(52) U.S. Cl. 352/85

(57) ABSTRACT

The present invention relates to a display for motivating or inducing behaviour or arousal in a subject. It includes a plurality of image frames displayed in a stereograph which may be used to motivating, inducing or discourage a specified behaviour or form of arousal. One application is use in a public area such as a retail environment with a small number of the image frames include symbols to either encourage or discourage the consumer from moving towards or away from desired product and/or encourage purchase of the product. Product brands and or slogans may also be included in one or more frames.

### TECHNICAL FIELD

The present invention relates to motivation means and related methods an in particular although not solely to methods employed to motivate and/or suggest the decision making and/or movement of consumers when purchasing to encourage purchasing.

### BACKGROUND OF THE INVENTION

The motivating force behind human behaviour can be explained in terms of avoiding pain and moving towards pleasure. Such has been explained in the theories of Neuro-Associative conditioning & psychology of motivation. The ‘brain’ represents pain and pleasure in systematic ways in the majority of the population. The science of Neuro Linguistic Programming has defined the elements that allow the brain to define a stimulus of pleasure or pain and called these submodalities. Therefore it is possible using the correct submodalities to stamp a stimulus as pain or pleasure and so direct thinking.

It has been proven that the brain learns quickly and that the majority of people have a visual prime i.e. are programmed more easily visually than with other sense stimulus. It has also been shown that for the brain to link stimulus response several exposures are needed in a short period of time.

POPAI (Point of Purchase Advertising Institute) determined that of all purchasing decisions made in grocery and variety channels 70% were based on some form of in store decision. Only 30% were specially planned. Adding to this is the work done by Harvard psychologist Dr George Miller who determined that the average human mind cannot deal with more than seven units (plus or minus two) of information at a time. Accordingly stimulus at the point of sale is vital to affecting the consumers decisions.

The importance of the unconscious has been highlighted in recent years especially by the research of B Libet, who conducted a series of experiments that led to the conclusion that our actions begin unconsciously. Our consciousness is not the initiator-unconscious processes are. (B Libet Professor of neurophysiology University of California Medical Centre San Francisco).

In fact Libet proved that 0.5 seconds before any human consciously decides to do anything the brain has already begun the necessary activity (calculations) to allow the activity to take place.

Later studies led to an even more astonishing realization that consciousness performs a temporal readjustment backward, so that awareness of an outer stimulus is experienced as if it occurred immediately after the stimulus is experienced, even though in fact half a second passed before conscious awareness.

Consciousness portrays itself as the initiator, but it is not, events have already started by the time consciousness occurs.

Libet in the face of this information then looked at the concept of free will and determined that the conscious mind has 0.2 seconds to Veto any urge generated from the unconscious mind. He also concluded that humanity do not ‘enjoy’ using the veto mechanism and in fact the veto mechanism is mostly used in situations that would be labelled as ‘negative’.

This research led Libet to conclude that we can control our actions but not our urges.

### SUMMARY OF INVENTION

It is therefore an object of the present invention to provide motivation means and related methods which will at least provide the public with a useful choice. It is a further object of the present invention to provide a motivation means and related method which seeks to systematically construct specific urges in the consumers mind by presenting images in a specific pattern and structure.

Accordingly in a first aspect the present invention consists in a system to induce specific urges in a subjects mind comprising of a stereograph which is provided with at least two images visible substantially from two different viewing orientations in respect of said subject,

wherein a first image of said at least two images is visible from a significantly reduced viewing orientation in respect of at least one of any other of said at least two images.

Preferably said first image is of a kind presenting positive perception or connotations

Preferably all images other than said first image presents a brand, brand related or product related image or images.

Preferably all images including said at least first image includes a brand, brand related or product related image.

Preferably said first image is preferably of a kind representing positive perception or connotations.

Preferably said stereograph includes a plurality of frames and said first image is provided in no more than two consecutive frames.

Alternatively said stereograph has at least ten frames and said first image is provided in one frame.

Alternatively said stereograph includes at least ten frames, and a plurality of minimum viewing orientation exposure images may be provided in non sequential frames.

Preferably said first image may be an image providing information, a brand, or an arousal image.

Preferably the stereograph is adapted to provide a sequence of images wherein the outer most visible image is of a minimum exposure and provides a mind map with associated geometrical shapes, said shapes appearing in subsequent images in a sequence in accordance with that of the mind map.

Preferably said stereograph is adapted to provide a sequence of images wherein the image of a brand is provided several times as a minimum exposure and is separated by a non brand related image.

Preferably the brightness, density, opacity and or contrast of said first image is adapted to reduce said subjects conscious awareness of said first image.

In a further aspect the present invention consists in a method of inducing behaviour in a subject comprising:

presenting from a fixed location a first image substantially only visible in a first region presenting from said fixed location a second image substantially only visible in a second region wherein said first image of a kind being of a negative perception or connotation representing pain submodalities and said second image is of a kind presenting positive perception or connotations representing pleasure submodalities.

Preferably said fixed location is a structure such as for example a shelf, wall, floor or means suspended from a ceiling or the like from which image presenting mean is disposed, fixed or located.

Preferably it is desirous for said subject to move towards said second region which will increase the probability of the purchase of a consumer product or products in said second region and said method is adapted accordingly.

Preferably said second region is a region which is in substantial overlap with a region extending laterally outwardly from a product display means (such as a shelving providing means) on or onto which goods can or are presented which are desired to have their probability of sale enhanced.

In a further aspect the present invention consists in a system for inducing behaviour in a subject comprising:

an image presenting means secured at a fixed location in respect of a, or a region of consumer product(s), adapted to present at least two images with at least one image only substantially visible from a first or a second region,

a first image when said subject is in said first region of a kind being of a negative perception or connotation representing pain submodalities, and

a second image when said subject is in said second region of a kind presenting positive perception or connotations representing pleasure submodalities,

said second region and said first region orientated to urge the subject to move in a desired direction or towards a particular area.

method of inducing motivating behaviour in shopping/purchasing environments comprising;

providing an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:

a) the movement of the person relative to a stationary image presenting means and/or

b) movement of the image presenting means relative to a stationary said person, wherein

a first image is of a kind being of a negative perception or connotation presenting pain submodalities and the second image is of a kind presenting positive perception or connotation representing pleasure submodalities.

In a further aspect the present invention consists in a system for providing an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:

a) the movement of the person relative to a stationary image presenting means and/or

b) movement of the image presenting means relative to a stationary said person,

wherein

a first image is of a kind being of a negative perception or connotation presenting pain submodalities and the second image is of a kind presenting positive perception or connotation representing pleasure submodalities.

Preferably said image presenting means is of a kind having a refraction surface which through movement of the view point of the user of the means, the image that is refracted can change.

Preferably said fixed location is for example a shelf or shelving arrangement, wall, means suspended from a ceiling, floor or any like structure which can preferably remain secured and fixed in location relative to consumer products in there shelved or stored condition.

Preferably said image presenting means is present from said fixed location at a level visible to a person when at least in a standing upright condition.

Preferably said first image is of a kind which includes an image which is or includes any of the following,

black/white colour, and/or

a low brightness and/or

appears distant, and/or

lacks in clarity, and/or

small in size.

Preferably the image includes symbol(s) which is or include (but certainly not exclusively) an image of

snakes and/or

radiation symbol and/or

red light symbol and/or

stop sign and/or

jail cell or bars and/or

the word “tax” and/or

the word “toxic” and/or

a road sign implying danger and/or

skull and cross bones.

Preferably said second image is of a kind which includes an image which is or includes any of the following,

colour, and/or

a brightness which is significant, and/or

appears close from the view point of the person, and/or

image is clear, and/or

size of the image is large.

Preferably the image includes symbol(s) which is or include (but certainly not exclusively) an image of

a baby and/or

a happy face and/or

a flower and/or

the number “1” and/or

knights and/or

shield and/or

sun.

In a further aspect the present invention consists in a system for suggesting movement to a person comprising;

an image presenting means secured at a fixed location in respect of a, or a region of consumer product(s) said image presenting means being of a kind able to present two images each only substantially visible from a first or second region or direction, wherein intermediate of said first and second region or direction there is a mixed continuum of the said two images, wherein said image presenting means is in a fixed location in respect of said consumer product such that when a person is in said first region the image visible to said person is of a kind being of a negative perception or connotation representing pain submodalities, and when a person is in a said second region said image visible from said image presenting means is of a kind presenting positive perception or connotations representing pleasure submodalities, said second region being more proximate than said first region, to consumer goods which are desired to have their probability of sale enhanced.

Preferably said second image is in substantial overlap with a region extending outwardly from the exposed region of the shelf or display of the products system for inducing behaviour or arousal in a subject comprising:

a display adapted to project at least two images,

a first image, and

a second image wherein the brightness, density, opacity, colour and/or contract adapted to reduce said subjects conscious perception or awareness of said second image.

Preferably said second image is visible from a significantly reduced viewing orientation in respect of said first image.

In a further aspect the present invention consists in a method of inducing motivating behaviour in shopping/purchasing environments comprising;

providing an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:

a) the movement of the person relative to a stationary image presenting means and/or

b) movement of the image presenting means relative to a stationary said person, wherein

a first of said at least two images adapted to be substantially consciously perceived or noticed by a person during said relative movement and a second of said at least two images adapted to be substantially subconsciously perceived or noticed by a person during said relative movement, wherein said second image is adapted to intermittently or periodically appear proximate to, overtop of, or replace said first image during said relative movement.

In a further aspect the present invention consists in a system for providing an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:

a) the movement of the person relative to a stationary image presenting means and/or

b) movement of the image presenting means relative to a stationary said person, wherein

a first of said at least two images adapted to be substantially consciously perceived or noticed by a person during said relative movement and a second of said at least two images adapted to be substantially subconsciously perceived or noticed by a person during said relative movement, wherein said second image is adapted to intermittently or periodically appear proximate to, overtop of, or replace said first image during said relative movement.

In a further aspect the present invention consists in a method of inducing motivating behaviour in shopping/purchasing environments comprising;

providing an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:

a) the movement of the person relative to a stationary image presenting means and/or

b) movement of the image presenting means relative to a stationary said person, wherein

a first of said at least two images adapted to be substantially consciously perceived or noticed by a person during said relative movement and a second of said at least two images adapted to be substantially subconsciously perceived or noticed by a person during said relative movement, wherein said second image is adapted to appear at least once prior to said first image during said relative movement.

In a further aspect the present invention consists in a system for providing an image presenting means visible to a person in the vicinity thereof wherein said image presenting means presents at least two images each only substantially visible by said person from a first or a second orientation of said person relative to said image presenting means, wherein said at least two images, from said persons perspective are changed as a result of:

a) the movement of said person relative to a stationary image presenting means and/or

b) movement of the image presenting means relative to a stationary person, wherein

a first of said at least two images adapted to be substantially consciously perceived or noticed by a person during said relative movement and a second of said at least two images adapted to be substantially subconsciously perceived or noticed by a person during said relative movement, wherein said second image is adapted to appear at least once prior to said first image during said relative movement.

In a further aspect the present invention consists in a method of inducing motivating behaviour in shopping/purchasing environments comprising;

providing an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:

a) the movement of the person relative to a stationary image presenting means and/or

b) movement of the image presenting means relative to a stationary said person, wherein

a first of said at least two images adapted to be substantially consciously perceived or noticed by a person during said relative movement and a second of said at least two images adapted to be substantially subconsciously perceived or noticed by a person during said relative movement, wherein said second image is adapted to intermittently or periodically appear during said relative movement.

In a further aspect the present invention consists in a system for providing an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:

a) the movement of the person relative to a stationary image presenting means and/or

b) movement of the image presenting means relative to a stationary said person, wherein

a first of said at least two images adapted to be substantially consciously perceived or noticed by a person during said relative movement and a second of said at least two images adapted to be substantially subconsciously perceived or noticed by a person during said relative movement, wherein said second image is adapted to intermittently or periodically appear during said relative movement.

To those skilled in the art to which the invention relates, many changes in construction and widely differing embodiments and applications of the invention will suggest themselves without departing from the scope of the invention as defined in the appended claims. The disclosures and the descriptions herein are purely illustrative and are not intended to be in any sense limiting.

The invention consists in the foregoing and also envisages constructions of which the following gives examples.

### BRIEF DESCRIPTION OF THE DRAWINGS

One preferred form of the present invention will now be described with reference to the accompanying drawings in which;

FIG. 1 illustrate a stereograph in plan view and diagrammatically illustrates the nature of the different frames which can be viewed by a person in the vicinity of the stereo from different viewing angles, where the image arc for frame two has been shaded.

FIG. 2 illustrates a sequence of frames wherein an image such as a brand (B) is illustrated in alternative frames of the stereograph in order to enhance liking,

FIG. 3 illustrates a frame sequence adapted to enhance arousal of a person which is hereinafter described in more detail,

FIG. 3A illustrates an alternative frame sequence to that of FIG. 3,

FIG. 4 illustrates a frame sequence wherein the frames provide information and are arranged in a sequence to increase the involvement and hence learning of a person in its vicinity,

FIG. 5 illustrates a frame sequence presenting images and information to enhance the linking of an emotional response and a cause,

FIG. 6 is a schematic illustration showing from the perspective of a person and illustrates the physical viewing directions that a person will adopt for different thought processes,

FIG. 7 illustrates how a stereograph may be arranged with images/information to correspond with the physical viewing directions as shown in FIG. 6,

FIG. 8 further illustrates the positioning of images/information for the different type of buying strategies that are herein by way of example described, wherein the different frames become visible from different angles or different proximities to the stereograph,

FIG. 9 illustrates a frame sequence which can be utilised to enhance anchoring as herein described,

FIG. 10 illustrates frame sequences which can be utilised with the benefits of mind mapping.

FIG. 11 is a perspective view of a shelving arrangement which incorporates the image presenting means of the present invention,

FIG. 12 is a plan view of FIG. 1 illustrating a person in the vicinity of the image,

FIG. 13 illustrate regions of visibility of the images providing positive and negative signals wherein the strength of the visibility of the positive and negative images varies in respect of the viewing position of the person in its vicinity,

FIG. 14 is a perspective view illustrating the movement suggesting means incorporated in a, for example supermarket shelf arrangement to induce or suggest movement of a shopper in a certain direction or at least away from another direction, and

FIG. 15 shows a series of frames wherein the a large sequence is of images representing pain, then over 2-4 frames a pleasure image is presented which expands in size (whether centrally of from a corner) and which is then followed by positive images. Dependent on the number of frames in a stereograph, this sequence may be repeated.

### DETAILED DESCRIPTION

Every second humans have 10⁹-10¹¹ bits of stimulus data entering the brain through the senses but the conscious mind can only hold 16 bits per second (Erlangen School Kupfmuller's diagram) therefore humanity experiences less than 1 millionth of the stimulus they receive. Presenting information below conscious threshold has been proven to impact the unconscious such that new or altered urges are generated.

In the preferred embodiment the term stereograph is used to describe a lenticular substrate with a pattern on the underside printed using interleaving techniques to present a different image or “frame” depending on the viewing orientation. The present invention is not limited to this construction and other stereograph like apparatus may also be employed to achieve the same end. For example 3D glasses may be employed instead of the lenticular substrate. A video image might replace the printed pattern. Similarly the actual position of the consumer could be sensed and an image changed accordingly, using electronics.

Using lenticular substrate creates that ability to have images move as successive frames are viewed. This allows images words etc to be moved and grown in specific ways which have a particular effect on human behaviour. It also allows for the colour or an image to change or for images to morph into each other where appropriate to create particular emotions etc.

This also allows below conscious threshold images to be generated through altering opacity levels and through minimum frame exposure. Altering the opacity level (brightness, contrast, colour, or density) may allow an image to be adequately inconspicuous such that the viewer is unlikely to consciously perceive or notice the image but will subconsciously take the information in. Similarity with minimum frame exposure images (only allowing an image to be viewable from a very small viewing orientation) moving subjects will only subconsciously perceive or notice the images or information and are not consciously affected. These images are able to successively change or sequence with other images to build a particular pattern.

The unconscious patterns that the present invention builds also can have specific effects on the way in which the above threshold information eg. brands are responded to this occurs not only in use but also later when only viewing the brand in a supermarket shelf. The above threshold and below threshold information work together to enforce unconscious patterns.

Lenticular substrate also allows for a significantly larger volume of information to be laid in below threshold verses an equivalent size piece of printed material. In the case of teaching new behaviours and or information the larger the amount of information that can be presented in the minimum possible time will have the greatest impact on memory and subsequent behaviour. Also due to the fact that for example 24 separate frames can be viewed in less than a second, it takes very little time for a consumer to have had a large number of exposures to a very large amount of information in a short space of time. (average time in front of a fixture in a super market is 15-20 seconds). The speed at which information in the present invention is transmitted 1) keeps the information from being consciously seen and 2) matches the optimal way the brain actually learns which is at very high speeds.

Minimum frame exposure will allow information to be given to the unconscious without the possibility of any conscious veto effect. Optical means such as the stereograph can present a varying number of frames ie between 15-45, therefore specific minimum frame exposure information can be placed in 2-5 non continuous frames only. This may alternatively be specified by a range of an angular visibility arc and may vary dependent on the nature of the use of the stereograph. Where there are situations where a rapid walk passed the stereograph normally occurs, the arc can be larger. In any event when the stereograph is viewed at a normal range of speeds the conscious mind will not be aware of the information presented in the non-continuous frames. It preferably ties back to the timing of the awareness in the conscious and subconscious mind.

Although generally herein illustrated are sequences of images which are in preference viewed in a motion of a person from left to right of the stereograph, the sequences of images may be reversed where predominately a person will walk from right to left. Indeed it may be possible for a stereograph to be utilised which will allow for images to be visually changed to a person as a person walks towards or away from the stereograph.

The information presented in the minimum frame exposures for optimum effect will in the preferred embodiment be at a brightness (alternatively opacity, contrast, density or colour) that would be at the threshold of an “average” persons ability to consciously perceive the information if the material was held stationary a exactly the correct angle.

With the use of stereograph means placed in a visible location to a person minimum frame exposure can be achieved. In particular if a stereograph of a kind described in U.S. Pat. No. 5,113,213 (the contents of which are incorporated herein by reference) is utilised which allows for a significant number of frames to be viewed from different viewing angles (or perhaps also different proximities) in respect of the stereo, a minimum frame exposure can be incorporated in the stereograph in average movement speeds of consumers in its vicinity and different techniques can be incorporated. Obviously it will be appreciated that where a person is perfectly still in respect of the stereograph that person will be able to view the image prescribed for minimum frame exposure for any length of time. However a consumer may not be aware of the existence of the image of the minimum frame exposure and it will not register for this person to attempt to consciously view this image(s).

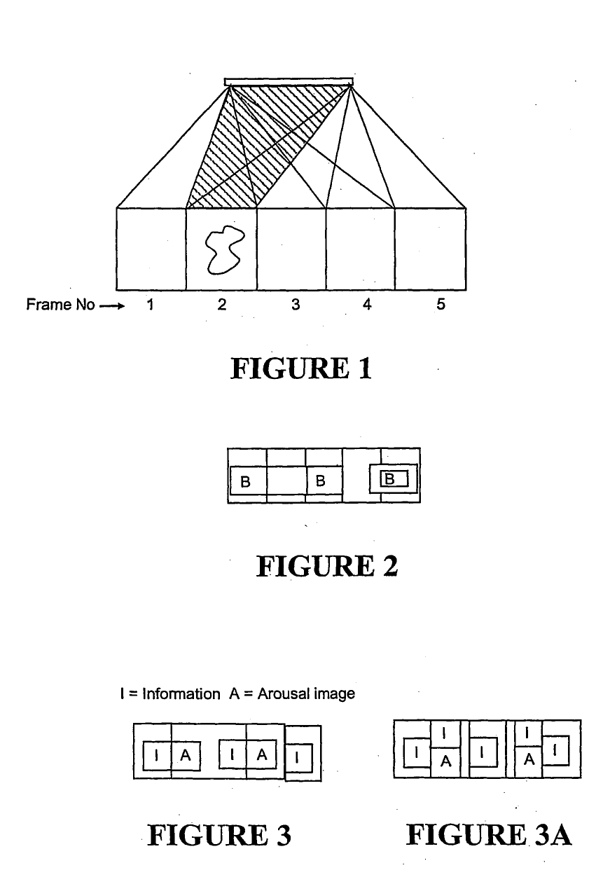

FIG. 1 illustrates a plan view of a stereograph and illustrates graphically five different frames which are viewable from different viewing angles in respect of the major surface from which the stereo effect is presented from.

In order to enhance the specific urges in a consumer several different techniques or a combination of techniques can be employed. The first of such techniques is herein referred to as priming. Exposure of information (e.g. brand and/or product) below conscious awareness to a person can at a later date when this information is shown at a conscious level create a familiarity and therefore enhances the likeability of the information. Showing information below the conscious awareness before showing the data at a conscious level is referred to as priming. Normally a person perceiving a familiar object is not aware that what is perceived is as much as an expression of memory as it is of perception. With reference to the present invention the priming effect can be created by laying into 1-2 frames of the stereograph (and therefore in respect of a common movement of a consumer in the vicinity of the device being below conscious awareness) of information such as brand or product. Consequently showing the brand or product at a conscious level in perhaps another medium such at t.v. or advertising will enhance the likeability of the product by the consumer. This is particularly so since a person when first presented with new information will in the conscious mind make a decision whether to veto or accept any urge relating to such information. The registration of a brand or product in the subconscious mind is hence likely to reduce any vetoing that might occur by the consumer.

The frames are arranged to enhance the priming effect of the present invention, the brand graphic is shown in the under exposure frames and hence is not normally consciously visible to the viewer. The frame may show the brand or product to register with the viewer in a subconscious state.

A second aspect in the way that the present invention may be utilised to enhance specific urges in a consumers mind is what is hereinafter referred to as liking. This aspect will provide information such as a brand, being presented so that a maximum number of exposures can be generated, in such a way that a brain recognises each exposure to the information as a new exposure and/or maximise the liking effect. With reference to FIG. 2 which illustrates a sequence of frames in respect of different viewing angles relative to the stereograph, the frames illustrating B show the brand whereas the frames intermediate thereof are minimum frame exposures providing an intermission of information between the frames showing the image. As a person moves relative to the stereograph an image/no image/image/no image sequence occurs wherein the “no image” is at a minimum frame exposure and is hence normally not consciously being perceived as an intermittent presentation of information

In terms of enhancing the memory of a person of particular information, the present invention can be employed to provide a technique herein referred to as arousal. In respect of this technique, the limbric brain dictates what information will be moved from short term to long term memory and emotional arousal is the key to triggering the limbric system to move information from the short to long term memory. The stereograph can be utilised by placing arousal images at regular intervals either as a separate frame or laid under the information. This will aid information being taken to shift to the long term memory. Such information may for example be a brand message. With reference to FIGS. 3 and 3A examples of separate frame sequences are shown wherein I is information and A is an arousal image at below the visible threshold. It is expected that a heightened ability to absorb information will result. Arousal images are for example images that are likely to elicit an emotional response, even at an unconscious level. Such may for example include beautiful nature scenes. Other images will be apparent to a person skilled in the art of advertising.

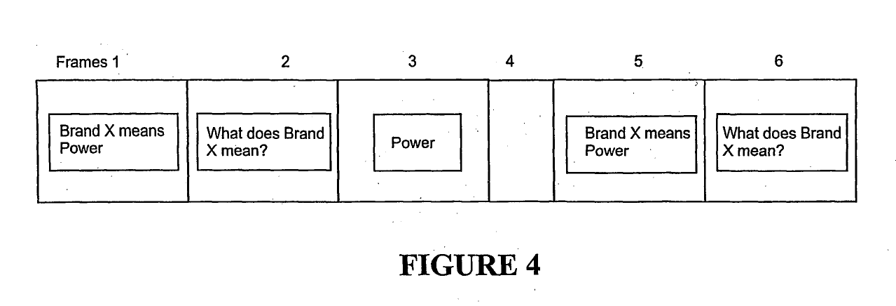

A second aspect of enhancing memory may include the adaptation of the stereograph to provide a technique herein referred to as involvement. The technique of active involvement in learning data can be more effective than simple rope learning. Testing learning is a very effective way of creating involvement particularly if the time between testing and learning is short. The stereograph of the present invention can be adapted to provide the techniques of learning by involvement by offering information forward, then testing it, then giving the answer and hence creating involvement at an unconscious level. With reference to FIG. 4 frames of a stereograph are shown wherein for example frame 1 is the frame providing information, frame 2 is asking a question, and frame 3 provides the answer. The stereograph can incorporate many frames this sequence can be repeated several times. For example frame 5, 6 is the next sequence following on from frames 1, 2, 3 and the minimum frame exposure of frame 4. The sequencing of frames 1-4 in a stereograph effectively generates a learn/test/learn/test sequence. The wording as shown in the frames are preferably of low intensity and in an unconscious location. A location may for example be provided in a lower corner of the frame and in fact being distracted therefrom another kind of image such as an arousal image. The wording is preferably provided in the same place in each frame that is appears in. A low brightness (colour/contrast) configuration and below threshold exposure is preferably utilised for such wording.

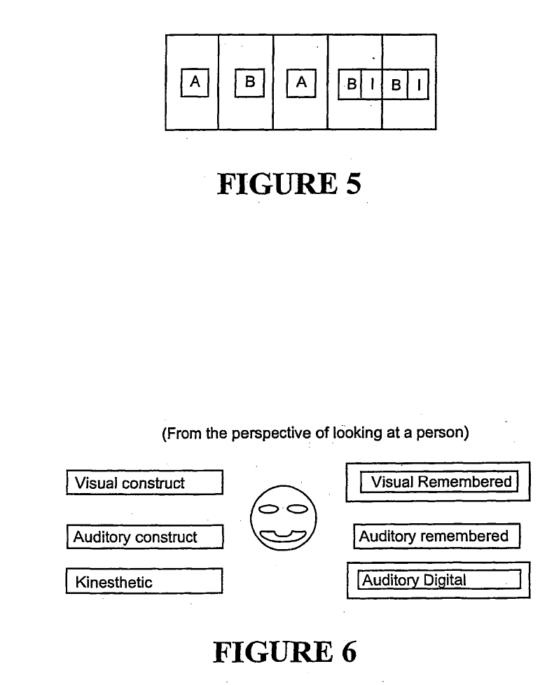

The stereograph can also include a technique which is herein referred to as mind map integration. Although mind maps are known, in the form of the present invention the stereograph will provide preferably in a outer most frame (left or right most), an image of a mind map which may include a sequence of symbols or markers that repeat themselves in the other frames preferably in the corners of images which are presented in the over exposed frames). By placing a mind map in one frame (frame 1 in FIG. 10) below the threshold exposure with specific symbols which act as mark view, the subsequent images that are visible and with the presence of the symbols in these subsequent images will enhance association and therefore memory. The specific symbols from the mind map could be laid into the subsequent frames to signal to the unconscious mind where in the sequence the person is viewing so allowing context to be created. The stereograph can also be adapted for a technique herein referred to as linking. For a brain to quickly and optimally be effected by this technique there must be very little time (preferably less than half a second) between the emotional response and the created cause (i.e. the brand). This may hence be achieved by the apparatus of the present invention through the use of images that arouse an emotional response being shown at below threshold and then showing at threshold information (the brand) so that an emotional response is linked to seeing the brand. Preferably and importantly the brand when it is presented above the threshold exposure it is placed exactly where the “emotional response” image was placed in the frame earlier. With reference to FIG. 5 such frames are for example shown where A is an arousal image and B is a brand related image and I is information.

In a further aspect the present invention can be adapted to present different frames at different viewing directions wherein information is provided in different locations of the image.

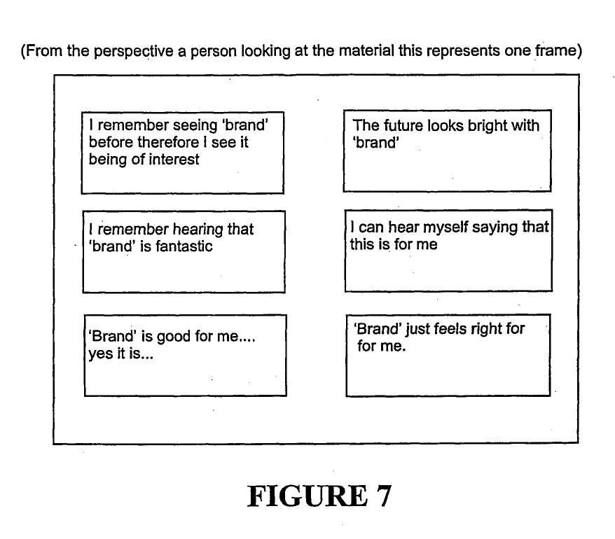

The average right handed human uses eye accessing cues to access different types of data. For example a person will on average look upwardly and to their right for thoughts relating to visual construction. With reference to FIG. 6, further regions are illustrated in respect of a persons eyes, to illustrate different physical sight directions of a person when particularly thought processes are occurring. By presenting information below threshold exposure in the regions of the stereograph there may be an increased likelihood that the suggestions would be acted on as information is presented in a manor in which people habitually process data. With reference to FIG. 7 and from a perspective of a person looking at the stereograph there was shown the types of information on the stereograph. Stereograph which will allow a frame to change from the viewing direction of a person, as a person walks directly towards it do exist. Therefore a person walling towards the stereograph can be presented with different information in different frames in different locations which correspond to a particular buying strategy that a person normally adopts in making a decision to purchase. As every human makes conscious decisions by processing information in a particular manner and sequence, if information is presented to the person in the manner in which they make such decisions then the likelihood of a person buying or liking a product should be increased.

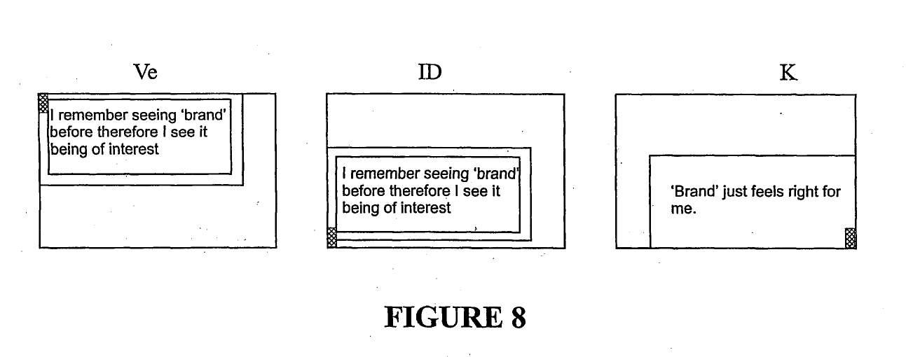

The buying strategy for the majority of the population may go (and with reference to FIG. 8) like this . . . Visual external (Ve)—see packaging—Internal dialogue (ID)—I need some ‘brand’ Kinesthetic (K)—it feels right purchase. The material would present by frame the buying strategy.

Using the techniques of NLP ‘strategy elicitation’ an individual buying strategy (or any other strategy) could be elicited and then the sequence i.e. Ve-ID-K laid into the material, with a brand focus. This would be delivered below threshold and because of the frame by frame delivery system would match a particular individual buying strategy i.e. Ve first ID second . . . Strategy elicitation could also be ‘averaged’ so as to present information to large groups of people to match the average strategy for buying, liking, loving etc.

FIG. 8 shows reference to these particular buying strategies and location of information within the frames.

The stereograph of the present invention can also be utilised to provide what is herein referred to as anchoring. Whenever a person is in an intense state where the body and mind are strongly involved together and a specific stimulus is consciously and simultaneously provided at such a peak state, the stimulus and the state become neurologically linked. In order not to dilute the effect of anchoring, it will be desirable for an unmistakable and very distinctive signal to be provided to the brain at the time of such a peak experience. For example when a person smiles the peak experience is happiness. However smiling is not unique response to being happy but can also be in response to other sensations. Therefore it is not an unmistakable and unique signal for such an experience. The use of a stereograph had the ability to deliver a unique and perfectly repeatable stimulus at both a conscious and unconscious level.

Using the technology whenever a subject either imagined or experienced a state that they would like to be able to automatically access again, at the peak of the experience they would view and move the technology so providing unique, perfectly repeatable stimulus. Because of the minimum frame expose capacity the specific stimulus could be presented and many times in the very short space of peak experience.

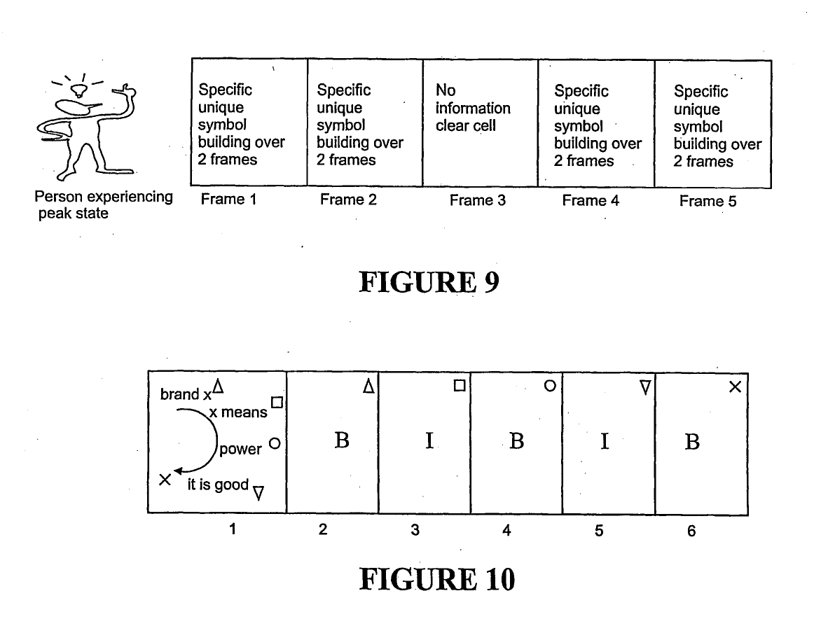

With reference to FIG. 9 this can for example be achieved by providing an arousal image first and then a second image (which may be a brand image). The stereograph can hence provide an arousal image immediately followed by an anchoring point.

The stereograph with appropriate imaging may also be adopted for what is herein referred to a Perceive-Conceive conditioning. Humans can only perceive, or literally see, what they can conceive of. Humans must have neuronal firing in their brains, whether it be in the part of the reason that the problem is not solved is the imagined state or actual perceptual state, for humans to register an object as a reality. With many human ‘problems’ i.e. obesity, e person can not conceive of being a ‘normal’ weight therefore they will not consciously perceive and therefore act on the necessary actions to reduce the problem.

The technology of the present invention can present information in such a way that perception of another alternative can be generated in the persons neurology. The process involves morphing from the state or situation now to the wanted state, this leads the mind from present to desired state. For maximum impact the actual facial features of the person could be total obscured in the present state and with every frame towards the desired state the facial features could become clearer until in the last frame the facial features were totally clear. Note it is important to use a mirror reflection image of the features as people mostly only see themselves in the mirror so like and relate to this representation of themselves better. Generic facial features can be use, for both actual and generic faces the expression must move from fear-unhappiness through to ecstatic joy.

In respect of the present invention certain types of imagery to enhance the brain sensitivity to a particular information should be utilised. Hans Jenny who has based on the work of the eighteenth century German physicist Ernest Chlandi, has pioneered a way of working with a ‘tonoscope’ that transforms sounds uttered into a microphone into their visual representation on a video screen.

Sentences can be captured on the ‘tonoscope’ as well as individual words or sounds, these images can then be place sequentially into the technology of the present invention to potentially produce the same effect as if the words or sound had been actually said. This creates the opportunity for this technology to generate a state of Synesthesia (stimulating one sensory response via another sense in a crossover effect in this example auditory information is presented in a visual medium with visual information). This is possible because the brain does not in reality see hear of taste any thing, all that is generated is initially electrical impulses whether these impulses come from the auditory ‘I LOVE YOU’ or the tonoscope representation of these words is irrelevant. The tonoscope representation is actually more likely to be effective description will not be consciously seen as a word or series of words so there will be no veto effect therefore it will be delivered directly to the unconscious.

| Brand X | IS | Good |
|---|---|---|
| (Tonoscope | (Tonoscope | (tonoscope |
| representation | representation | representation |
| of the above words.) | of the above words) | of the above words) |

Particular words that have an arousal effect on the limbic system can also be put into frames to create interest and to link to the main feature of the frame in a minimum frame exposure level or at a conscious level.

For maximum effectiveness the tonality of the spoken world the loudness the number of people saying the word the sex of the people saying the word would be calculated based on the desired effect.

For example if the objective was to build excitement from frame 1 and have it crescendo in frame 24 the tonoscope image would be of 1 person saying for example victory, as the frames moved on the loudness and number of people saying victory would increase (this would impact the shape of the pattern and the brightness of the lines) people

In a further aspect, the device also allows at least 2 different pictures to be observed in a continuum from full to mixed distinction depending on the amount of lateral movement of the eyes including the position of the person with respect to the device, the visual information designed using the basic submodalities of pain and pleasure so that the behaviour that is wanted is framed in terms of pleasure and the behaviour not wanted is framed in terms of pain. As the eyes move laterally one picture fades into the other so programming the unconscious. Every new exposure increases the richness of the link and the likelihood of a particular stimulus i.e. seeing a particular brand, producing a higher propensity to act in a particular way i.e. purchase.

The image basic submodality list may include

| | Away | Toward |
|---|---|---|
| Colour | Black & White | Colour |
| Brightness | Dim | Bright |
| Proximity | Farther away | Close |
| Clarity | Fuzzy | Clear |
| Size | Small | Large |

The images may for example also be as follows

| Positive | Negative |
|---|---|
| a baby | Snakes |
| a happy face | radiation symbol |
| a flower | red light symbol |
| number 1 | stop sign |
| knights | jail cell or bars |
| shield | the word “tax” |
| sun. | the word “toxic” |
| | a road sign implying danger |
| | skull and cross bones. |

As well as providing movement suggestion to customers within the vicinity of the device, the device in combination with suggestion movement or separately, provides for neuro associated conditioning. The preferred means of presenting the images is that of stereograph of a kind having a refraction structure wherein from one direction or region one image is visible and from the other direction or region the other of said images is visible, and as a result of movement of a customer in relation to such a fixed image presenting means or by of the movement of the image presenting means itself (by for example a mechanical or electromechanical or electrical device) results in the presentation of different, alternating images to the customer in the vicinity of the means. It is known from associative conditioning theory that subjecting a person to changing images of a kind as herein suggested results in appropriate and desirable conditioning of a persons brain.

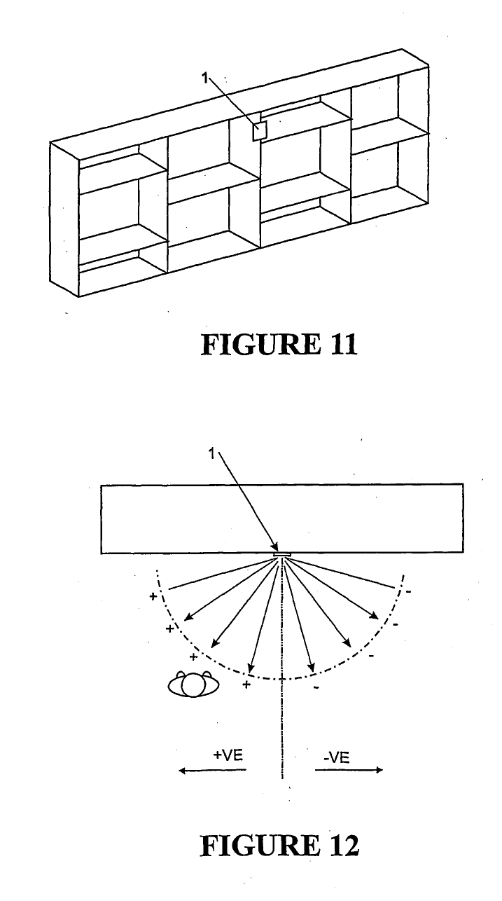

With reference to FIG. 11 the stereograph 1 is preferably secured to a structure, which for example is a supermarket or the like shelving arrangement so that it is visible to a person in its vicinity from at least two regions. The stereograph 1 is of a type that allows at least two different pictures to be observed. The pictures may be viewed or observed from at least two different regions and indeed the present invention is not limited to where such regions are entirely distinct or are in partial overlap. Where such are in for example a partial overlap a mix of said at least two pictures may be visible in a continuum from part of the at least two regions. When the eyes of a person are in a first of said regions, a first of said image is visible and when said the eyes of a person are in the other of said regions, a different picture is visible. Intermediate of the regions or when said regions are considered an overlap, a mixed continuum of said images is visible. The stereograph is preferably of a kind which has a diffraction structure which through lateral or pivoted motion in respect of a viewers eyes, allows for at least two different pictures to be presented in a continuum. When a diffraction type structure is used, the two images are incorporated in the same object and presented from the same regions of said object but a mere rotation allows for a different perspective of the object to be viewed. It may however be that the stereograph has a first region which is substantially blank when viewed from one direction but illustrates an image when viewed from another direction, and they have a second region which is vise versa.

FIG. 12 illustrates a plan view of an arrangement of the present invention wherein said stereograph is located from a structure such as a supermarket shelf arrangement and illustrates the at least two regions from which one or the other of said images of said stereograph is visible. The images which are presented are of a kind which are likely to induce movement in a desired direction. This is achieved by positioning the stereograph to present an image visible to a person in a region or towards a region where the movement of the person is desired to be towards, and presents an image representing pain or displeasure visible in a region or towards a direction in which it is undesirable for the person to be in or to move towards. As the human mind would prefer to move towards a state of pleasure and away from pain, the apparatus and method of the present invention will stimulate the mind and will subconsciously persuade a person who is in the vicinity of the stereograph of the present invention to move towards or in a certain direction or away from anther direction. With the presence of products which are desired to be sold, within a region where the positive image of the stereograph is visible, it is suggested that increase sales of such products are induced to occur. The arrangement of the stereograph such that the positive images or image presented therefrom is visible from such regions, should enhance sales. In those regions where the negative images are visible, the invention will more frequently and/or rapidly result in people moving away from such regions. Such regions may be areas in a shop or supermarket which serve no sale inducing purposes, such as the trolley storage area,

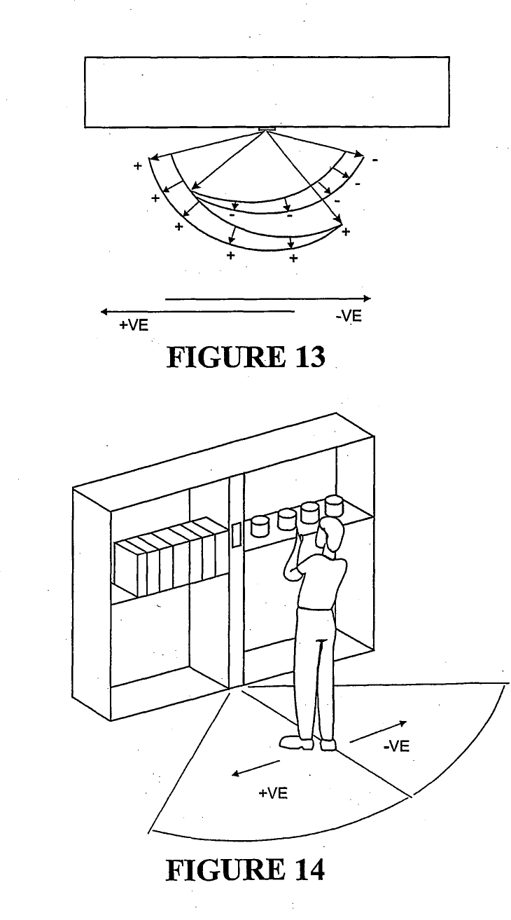

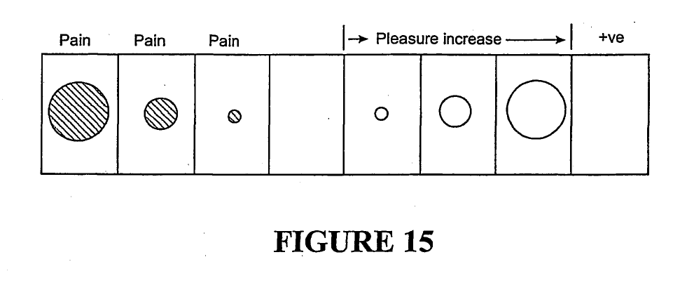

With reference to FIG. 13, the stereograph may be such that there is an overlap in the regions of the where a positive image is visible and a negative image is visible. FIG. 3 illustrates how in an increasing clarity or visibility, a negative or a positive image becomes visible as a person moves left in respect of the stereograph, and vice versa for the negative image. It is therefore to be appreciated that there may a region, in diminished visibility, both types of images are visible. With the movement one way or the other, a positive or negative image becomes clearer.

The stereograph of the present invention may be associated to any suitable structure with in a supermarket or shop or the like and although we have shown herein it being attached to a shelf, it may be attached to products, walls, flooring or the like. Other locations to for the purposes of the techniques such as linking, liking, mind-map integration, priming, and enhancement, are also possible. Such may be in any suitable location where the target market will see the stereograph. Such may be by providing stereograph in shop windows, as mailouts, perhaps with magnetic backing to encourage their use as fridge magnets, as car stickers, mouse pads etc. As long as the images are visible (whether consciously or not) by a person in its vicinity.

It will be appreciated that through out the desciption and claims, where movement of the subject is used to achieve an effect the effect can equally be achieved by moving the sterograph.

Pavlovian Conditioning

Lenticular substrate due to the number of frames that it presents a viewer has the ability to flash information, which will be perceived below conscious threshold, in a specific manner in relation to above consicous threshold imagery ie the image of a Brand. The below threshold flashing maybe used to allow a very strong Pavlovian pattern to be built.

Pavlovian response (Pavlovian conditioning, based on the work of Nobel prize-winning physiologist Ivan Pavlov) is the learning of an associatoin between two previously unrelated stimuli as a result of proximity in space and time. This is generally called classical conditional markerting. The present has the ability to flash information ie symbols/words in a below consious threshold manner close to or under a brand which exists at or above consious threshold so that the subconscious creates a strong emotional reaction. This is emotionally linked to the brand all in a very short space of time all by passing any conscious mind moderation. The more often a Pavlovian pattern can be observed the stronger the pattern becomes the present invention can effectively encode multiple times in a very short space of time. The building of a Pavlovian pattern in this way will build a very strong Poetzle effect where by when a consumer otherwise sees the brand it will be likely to trigger the emotions generated by the present invention and then attaced to the brand.

Multisensory Encoding

The more sensory systems that information can be presented in the more likely it is to be retained in long term memory. This phenomenon is often called Multi-sensory-encoding. Encoding using below conscious threshold methodologies are more effective than the presentation of the same information above conscious threshold. Using the lenticular substrate with minimum exposure frames and appropriate opacities, (contrast, colour, or brightness) information can be encoded in different representational systems and within mulitple aspects of the same representational system. For example in print the only representational system involved is sight as touching the page does not give any specific information about the product, the page is unlikely to smell or to have any ability to communicate any specific sound. The device however has the ability to encode very deeply into the visual representational system as any image can move successively change colour and shape and also have depth to them based on the fact that a lenticular lens has the ability to make images look 3 dimensional ie. Give the impression of depth. As described in the foregoing the present invention also has the ability to present visual information in a way that may fire the auditory cortex as well so increasing the number of representational systems that the device can encode information in.

Experimental Results

In order to verify the general propositions in the foregoing an confidential experiment was commissioned.

Subjects

Subjects were one 25 year old male (S1) and one 21 year old female (S2). Both were normal subjects with no known neurological abnormalities.

EEG Recordings

Electrical Geodesics Inc. 128-channel Ag/AgCl electrode nets were used. EEG was recorded continuously (250 Hz sampling rate; 0.1-100 HZ analogue bandpass) with Electrical Geodesics Inc. Amplifiers (200 MΩ input impedance). Recordings were carried out in an electrically-shielded (Faraday room for attenuation of electrical interference. EEG signal cables left the shielded room via a cable port, and were digitise in the adjoining control room with a National Instruments PCI-1200 12 bit analogue-to-digital conversion card controlled by acquisition software running on a Power Macintosh 9600/200 computer. Electrode impedances were below 40 kΩ. EEG was acquired using a common vertex (Cz) reference, and then re-referenced to the average reference in off-line analyses. Subjects were continuously monitored by a closed-circuit video camera.

Visual Displays

Static and dynamic visual displays were presented in a custom-made holder which allowed for manual rotation of the photographs in the vertical direction. Subjects viewed the photographs at a distance of 57 cm.

Event-Synchronization

A colour video camera was placed behind the subjects and fixed on the visual displays. Video output was directed to a monitor in the experimental control room. Video output was mixed with the clock counter output of the EEG analogue-to-digital conversion card and recorded with a video cassette recorder. At the beginning of an experimental session, the clock counter on the video display was initialised. This counter initialisation simultaneously resulted in a TTL trigger pulse being sent to the EEG acquisition machine. Thus synchronization was achieved in subsequent analyses by aligning the start of the clock on the video display with the trigger pulse on the EEG recording.

Fourier Analysis

Fast Fourier Transforms (FFTs) were performed on data from selected analysis intervals. FFTs allows the EEG to be decomposed into functionally distinct frequency bands. Three major frequency bands are of interest in the waking human EEG (different frequency bands are associated with various stages of sleep):

Theta band (3-7 Hz): Characteristic of waking EEG. Experimentally associated spatial navigation and memory retrieval processes;

Alpha band (8-12 Hz): Characteristic of relaxed wakefulness. Amplitude increases dramatically when eyes are closed.

Beta band (13-30 Hz): Characteristic of alertness and behavioural arousal. Associated with active processing of information. Beta-band activity is of most functional relevance for the purposes of the present project, and the remaining analyses will focus on the effect of experimental variables on this measure of brain activation.

FFT amplitude spectra for the two subjects indicated S1 exhibits higher alpha band activity and lower beta band activity than S2. Idiosyncratic differences in EEG profiles are stable and reliable reflections of individual differences in brain organization and function.

An amplitude peak at 50 Hz (particularly evident in S1) is the result of alternating current fields generated by electrical devices in the environment. This electrical “noise” is evident in only 1 or 2 channels in each subject, resulting from less-than-perfect contact between the scalp and the electrode.

Results

Initial viewing of the static picture results in activation over the central region of the head (rather lateralised to the left), and over the frontal region (distinctly lateralised to the right). In comparison, viewing of the dynamic picture (i.e. the present invention with relative movement) results in increased activation in both of these regions. Subsequent viewing of the static picture shows that this increased activation is maintained, and even increased in the frontal region, in comparison to initial viewing.

This was replicated in subsequent iterations where the second viewing of the static picture results in increased activation of central and frontal in comparison to both the first static viewing and the dynamic viewing.

S2 as with S1, had activation occuring in frontal regions, but also in posterior regions (overlying the occipital, or visual areas of the brain). Activations are not seen in central regions in this subject.

Again in comparison to initial viewing of the static stimulus, the dynamic stimulus (ie. the present invention with movement) results in slightly increased activation of frontal regions. A similar region is activated with subsequent viewing of the static picture, with additional activation of the occipital region.

### Conclusions

In comparison to initial viewing of a static picture, the present inventon resulted in increased brain activation on subsequent viewing of the static picture. This pattern of results was replicated within a subject and between subjects. The probability of obtaining this pattern of results by chance is 1/216.

The static/dynamic/static stimulus sequence produced the same pattern of brain activation (low/medium/high) when the dynamic stimulus was presented for 5 s, 20 s or 40 s.

1. A system to induce specific subconscious urges in a subjects mind comprising of a stereograph which is provided with at least two images visible substantially from two different viewing orientations in respect of said subject,
wherein a first image of said at least two images is visible from a significantly reduced viewing orientation in respect of at least one of any other of said at least two images, in a manner such that said at least one of any other of said at least two images are consciously visible to a subject moving relative to said stereograph and said first image is non obvious to such subject.

2. The system as claimed in claim 1 wherein said first image is of a kind presenting positive perception or connotations representing pleasure submodalities and is provided in at least one frame of the stereograph.

3. The system as claimed in any one of claims 1 or 2 wherein all images other than said first image presents a brand, brand related or product related image or images.

4. The system as claimed in any one of claims 1 or 2 wherein all images including said at least first image includes a brand, brand related or product related image.

5. The system as claimed in any one of claims 1 to 4 wherein said first image is preferably of a kind representing positive perception or connotations.

6. The system as claimed in any one of claims 1 to 5 wherein said stereograph includes a plurality of frames and said first image is provided in no more than two consecutive frames.

7. The system as claimed in any of claims 1 to 5 wherein said stereograph has at least ten frames and said first image is provided in one frame.

8. The system as claimed in any of claims 1 to 5 wherein said stereograph includes at least ten frames, and a plurality of minimum viewing orientation exposure images maybe provided in non sequential frames.

9. The system as claimed in any one of claims 1 to 8 wherein said first image may be an image providing information, a brand, or an arousal image.

10. The system as claimed in any of claims 1 to 9 wherein the stereograph is adapted to provide a sequence of images wherein the outer most visible image is of a minimum exposure and provides a mind map with associated geometrical shapes, said shapes appearing in subsequent images in a sequence in accordance with that of the mind map.

11. The system as claimed in any one of claims 1 to 9 wherein said stereograph is adapted to provide a sequence of images wherein the image of a brand is provided several times as a minimum exposure and is separated by a non brand related image.

12. The system as claimed in any one of claim 1 to 11 wherein the brightness, density, opacity and or contrast of said first image is adapted to reduce said subjects conscious awareness of said first image.

13. A method of inducing behaviour in a subject comprising:
presenting from a fixed location a first image substantially only visible in a first region presenting from said fixed location a second image substantially only visible in a second region wherein said first image of a kind being of a negative perception or connotation representing pain submodalities and said second image is of a kind presenting positive perception or connotations representing pleasure submodalities.

14. The method as claimed in claim 13 wherein said fixed location is a structure such as for example a shelf, wall, floor or means suspended from a ceiling or the like from which image presenting mean is disposed, fixed or located.

15. The system as claimed in any one of claims 13 or 14 wherein it is desirous for said subject to move towards said second region which will increase the probability of the purchase of a consumer product or products in said second region and said method is adapted accordingly.

16. The system as claimed in any one of claims 13 to 15 wherein said second region is a region which is in substantial overlap with a region extending laterally outwardly from a product display means (such as a shelving providing means) on or onto which goods can or are presented which are desired to have their probability of sale enhanced.

17. A system for inducing behaviour in a subject comprising:
an image presenting means secured at a fixed location in respect of a, or a region of consumer product(s), adapted to present at least two images with at least one image only substantially visible from a first or a second region,
a first image when said subject is in said first region of a kind being of a negative perception or connotation representing pain submodalities, and
a second image when said subject is in said second region of a kind presenting positive perception or connotations representing pleasure submodalities,
said second region and said first region orientated to urge the subject to move in a desired direction or towards a particular area.

18. A method of inducing motivating behaviour in shopping/purchasing environments comprising;
providing an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:
a) the movement of the person relative to a stationary image presenting means and/or
b) movement of the image presenting means relative to a stationary said person, wherein
a first image is of a kind being of a negative perception or connotation presenting pain submodalities and the second image is of a kind presenting positive perception or connotation representing pleasure submodalities.

19. A system for providing an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:
a) the movement of the person relative to a stationary image presenting means and/or
b) movement of the image presenting means relative to a stationary said person, wherein
a first image is of a kind being of a negative perception or connotation presenting pain submodalities and the second image is of a kind presenting positive perception or connotation representing pleasure submodalities.

20. The system as claimed in claim 19 wherein said image presenting means is of a kind having a refraction surface which through movement of the view point of the user of the means, the image that is refracted can change.

21. The system as claimed in any one of claims 19 or 20 wherein said fixed location is for example a shelf or shelving arrangement, wall, means suspended from a ceiling, floor or any like structure which can preferably remain secured and fixed in location relative to consumer products in there shelved or stored condition.

22. The system as claimed in any one of claims 19 to 20 wherein said image presenting means is present from said fixed location at a level visible to a person when at least in a standing upright condition.

23. The system as claimed in any one of claims 19 to 22 wherein said first image is of a kind which includes an image which is or includes any of the following,
black/white colour, and/or
a low brightness and/or
appears distant, and/or
lacks in clarity, and/or
small in size.

24. The system as claimed in claim 23 wherein the image includes symbol(s) which is or include (but certainly not exclusively) an image of
snakes and/or
radiation symbol and/or
red light symbol and/or
stop sign and/or
jail cell or bars and/or
the word “tax” and/or
the word “toxic” and/or
a road sign implying danger and/or
skull and cross bones.

25. The system as claimed in any one of claims 19 to 22 wherein said second image is of a kind which includes an image which is or includes any of the following,
colour, and/or
a brightness which is significant, and/or
appears close from the view point of the person, and/or
image is clear, and/or
size of the image is large.

26. The system as claimed in claim 25 wherein the image includes symbol(s) which is or include (but certainly not exclusively) an image of
a baby and/or
a happy face and/or
a flower and/or
the number “1” and/or
knights and/or
shield and/or
sun.

27. A system for suggesting movement to a person comprising;
an image presenting means secured at a fixed location in respect of a, or a region of consumer product(s) said image presenting means being of a kind able to present two images each only substantially visible from a first or second region or direction, wherein intermediate of said first and second region or direction there is a mixed continuum of the said two images, wherein said image presenting means is in a fixed location in respect of said consumer product such that when a person is in said first region the image visible to said person is of a kind being of a negative perception or connotation representing pain submodalities, and when a person is in a said second region said image visible from said image presenting means is of a kind presenting positive perception or connotations representing pleasure submodalities, said second region being more proximate than said first region, to consumer goods which are desired to have their probability of sale enhanced.

28. The system as claimed in claim 27 adapted such that said second image is in substantial overlap with a region extending outwardly from the exposed region of the shelf or display of the products.

29. A system for inducing behaviour or arousal in a subject comprising:
a display adapted to project at least two images,
a first image, and
a second image wherein said display includes a refraction surface which results in the projection for viewing of said images in discrete directions,
and wherein said second image is of a brightness, density, opacity, colour and/or contrast adapted to reduce said subjects conscious perception or awareness of said second image, and
wherein the visibility of said second image is non obvious to the subject moving relative to said display, as a result of the range of directions from which said first image is viewable being significantly greater than for said second image.

30. A system according to claim 29 wherein said second image is visible from a significantly reduced viewing orientation in respect of said first image.

31. A method of inducing or motivating behaviour in a person comprising;
providing an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:
a) the movement of the person relative to a stationary image presenting means and/or
b) movement of the image presenting means relative to a stationary said person, wherein
a first of said at least two images adapted to be substantially consciously perceived or noticed by a person during said relative movement and a second of said at least two images adapted to be substantially subconsciously perceived or noticed by a person during said relative movement, wherein said second image is adapted to intermittently or periodically appear proximate to, overtop of, or replace said first image during said relative movement.

32. A system comprising an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:
a) the movement of the person relative to a stationary image presenting means and/or
b) movement of the image presenting means relative to a stationary said person, wherein
a first of said at least two images adapted to be substantially consciously perceived or noticed by a person during said relative movement and a second of said at least two images adapted to be substantially subconsciously perceived or noticed by a person during said relative movement, wherein said second image is adapted to intermittently or periodically appear proximate to, overtop of, or replace said first image during said relative movement.

33. A method of inducing or motivating behaviour in a person comprising;
providing an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:
a) the movement of the person relative to a stationary image presenting means and/or
b) movement of the image presenting means relative to a stationary said person, wherein
a first of said at least two images adapted to be substantially consciously perceived or noticed by a person during said relative movement and a second of said at least two images adapted to be substantially subconsciously perceived or noticed by a person during said relative movement, wherein said second image is adapted to appear at least once prior to said first image during said relative movement.

34. A system comprising an image presenting means visible to a person in the vicinity thereof wherein said image presenting means presents at least two images each only substantially visible by said person from a first or a second orientation of said person relative to said image presenting means, wherein said at least two images, from said persons perspective are changed as a result of:
a) the movement of said person relative to a stationary image presenting means and/or
b) movement of the image presenting means relative to a stationary person, wherein
a first of said at least two images adapted to be substantially consciously perceived or noticed by a person during said relative movement and a second of said at least two images adapted to be substantially subconsciously perceived or noticed by a person during said relative movement, wherein said second image is adapted to appear at least once prior to said first image during said relative movement.

35. A method of inducing or motivating behaviour in a person comprising;
providing an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:
a) the movement of the person relative to a stationary image presenting means and/or
b) movement of the image presenting means relative to a stationary said person, wherein
a first of said at least two images adapted to be substantially consciously perceived or noticed by a person during said relative movement and a second of said at least two images adapted to be substantially subconsciously perceived or noticed by a person during said relative movement, wherein said second image is adapted to intermittently or periodically appear during said relative movement.

36. A system comprising an image presenting means visible to a person in the vicinity thereof wherein said image presenting means presents at least two images each only substantially visible by said person from a first or a second orientation of said person relative to said image presenting means, wherein said at least two images, from the persons perspective are changed as a result of:
a) the movement of the person relative to a stationary image presenting means and/or
b) movement of the image presenting means relative to a stationary said person, wherein
a first of said at least two images adapted to be substantially consciously perceived or noticed by a person during said relative movement and a second of said at least two images adapted to be substantially subconsciously perceived or noticed by a person during said relative movement, wherein said second image is adapted to intermittently or periodically appear during said relative movement.

37. A system for inducing or motivating behaviour in a person substantially as described as any of the embodiments herein, with reference to and as illustrated by any of the accompanying drawings.

38. A method of inducing or motivating behaviour in a person substantially as described as any of the embodiments herein.
